(19) United States
(12) Patent Application Publication
(10) Pub. No.: US 2023/0233993 A1
(43) Pub. Date: Jul. 27, 2023

(54) MANAGED ECOSYSTEM UTILIZING PRODUCED WATER FROM OIL AND/OR GAS RECOVERY OPERATIONS AND METHOD FOR SEQUESTERING CARBON DIOXIDE USING SAME

(71) Applicant: Saudi Arabian Oil Company, Dhahran (SA)

(72) Inventors: Donnie DURGADEEN, Dhahran (SA); Yousef M. DARDAS, Khobar (SA); Hessah M. MOOSA, Dammam (SA)

(21) Appl. No.: 17/582,086

(22) Filed: Jan. 24, 2022

(51) Int. Cl. B01D 53/85; B01D 53/62; C02F 1/44; C02F 1/463; C02F 1/467; C02F 1/00

(52) U.S. Cl. CPC B01D 53/85; B01D 53/62; C02F 1/44; C02F 1/463; C02F 1/467; C02F 1/008; B01D 2257/504; C02F 2103/10

(57) ABSTRACT

Managed ecosystems, methods for producing managed ecosystems and methods for using managed ecosystems for sequestering carbon dioxide are described herein. Produced water is obtained and purified to sustain a managed ecosystem with saline-tolerant vegetation. The managed ecosystem biologically sequesters carbon dioxide by photosynthetically absorbing carbon dioxide from the atmosphere and by decomposition into a layer of sediment on the ecosystem floor.

### BACKGROUND OF THE DISCLOSURE

### Field of the Disclosure

The presently disclosed subject matter relates to utilization of produced water from oil and/or gas recovery operations and methods for sequestering carbon dioxide.

### Description of Related Art

Water consumption worldwide is approximately 70% agricultural use, 22% industrial use, and 8% domestic use. A fifth of the world population lives in areas of water scarcity and one in eight lacks access to clean water. Readily drinkable water worldwide is less than 0.04%, further confirming its importance.

With the abundance of drilled and producing hydrocarbon wells, substantial water (produced water) is brought to surface alongside oil and gas. Produced water from oil and/or gas recovery operations is abundant, and considerable effort and expense is necessary for proper handling. The treatment and/or environmentally friendly disposal of this water is costly. It is estimated that treatment and disposal of produced water costs the industry more than 40 billion USD per year.

As drilled wells begin producing fluids, downhole pressure decreases and as a result, over time, produced water tends to increase. Substantial amounts of water is injected into the drilled hydrocarbon wells to bring deep oil to the surface. This injected water ultimately becomes part of the produced water, or is treated as wastewater. Due the ageing of wells, the water to oil ratio could jump from 3- to 12-fold by 2025.

Based on the origin, produced water can be classified as produced water from natural gas, oilfield or coal bed methane. In 2020, the planet's oil wells produced nearly 12.7 billion gallons a day of water, equivalent to more than 300 million barrels per day, 20% increase from 2007 where produced water averaged 250 million barrels per day.

The chemical and physical properties of produced water vary considerably and depend on several factors: geographic location, age and depth of the geological formation, hydrocarbon-bearing formation geochemistry, extraction methodology, type of produced hydrocarbon and the chemical composition of the reservoir. The produced water is saline in nature and can be treated and filtered to remove toxic elements and hydrocarbons.

For example, produced water can be used for waterflooding, pressure maintenance for hydrocarbon production and disposal sequestering strategies through injector wells across the various fields. With technological advancements, effective treatment of produced water can result in the water being recycled and used in other applications including crop irrigation, industrial processes, dust control, vehicle and equipment washing, power generation and fire control.

It has been found by the inventors herein that another solution is possible, particularly in areas with limited access to water of any kind. The world's deserts are vast with limited surface water, and of vegetation is scarce.

Saline-tolerant vegetation, such as mangroves, tidal marshes, and seagrasses are also unsustainable in natural deserts. Mangroves are tropical trees that have roots that can grow from its branches. Mangroves typically thrive in swamps and/or shallow seawater. They form clusters and harbor shrubs that grow generally in tidal areas, however, their ecosystem rank amongst the most threatened ecosystems globally. They are salt tolerant, whilst being home to a multitude of organisms and sea life. Mangroves can act as wind barriers, declassifying storms and shamals and create stability through their complex root system. Most importantly, however, for the world's longevity and sustainability, mangroves can sequester carbon dioxide (CO₂) over time. Together with other saline-tolerant vegetation, such as seagrass and tidal marshes, they can both absorb and store greenhouse gasses through their roots, tissue and leaves. Although mangroves are mostly found in tropical areas, worldwide they cover comparatively less than 3 percent the extent of the Amazon rainforest. However, mangroves remain powerhouses when it comes to carbon storage as they can sequester up to four times more carbon than rainforests. Research has also established that mangroves and seagrasses can sequester up to ten times more CO₂ per unit area than terrestrial forests.

As mangroves, tidal marshes, and seagrasses grow and die, captured carbon, or “blue carbon,” cycles into thick layers of sediment on the sea floor, where it can be stored undisturbed for centuries. The expanse of this saline-tolerant vegetation across vast areas can help remove CO₂ from the atmosphere. Countries such as Senegal, Cambodia and Thailand have all gained positively from “man-made” mangroves ecosystems which help facilitate livelihoods in impoverished villages. Natural mangroves also exist in Saudi Arabia in places like Farasan Island and the Red Sea coastline. For example, the King Abdullah University of Science and Technology continues research into thirty (30) species of mangroves and twelve (12) species of seagrasses that could be adapted to harsh desert conditions such as found in Saudi Arabia.

The Ocean Carbon and Biogeochemistry (OCB) program, established in 2006 as one of the major activities of the United States Carbon Cycle Science Program, is an interagency body that coordinates and facilitates activities relevant to carbon cycle science, climate, and global change issues. They have stated that coastal wetlands such as mangroves, tidal marshes, and seagrasses effectively sequester carbon long-term, with up to 10× more carbon stored per unit area than terrestrial forests with 50-90% of the stored carbon residing in the soil. The ocean represents the largest active carbon sink on Earth, absorbing 20-35% of anthropogenic CO₂ emissions.

In regard to the above background information, the present disclosure is directed to a technical solution for utilization of produced water, and for sequestration of atmospheric CO₂.

### SUMMARY OF THE DISCLOSURE

The above needs are realized and other advantages are provided by the systems and methods that advantageously uses produced water from oil and/or gas recovery operations to sustain a managed ecosystem that sequesters atmospheric CO₂. The presently disclosure relates to managed ecosystems utilizing produced water from oil and/or gas recovery operations, and methods for using managed ecosystems for sequestering carbon dioxide.

A managed ecosystem comprises a basin configured and dimensioned to hold a quantity of water; an influent flowline in fluid communication with a source of, and adapted for receiving and discharging into the basin, produced water from oil and/or gas recovery operations; an effluent flowline in fluid communication with, and adapted for discharging into, a water storage tank/reservoir/well and/or an injector well; wherein the basin contains a plurality of saline-tolerant vegetation that is sustained by said produced water. The influent flowline of the managed ecosystem is in fluid communication with, and adapted for receiving purified produced water from, a produced water treatment sub-system. The produced water treatment sub-system is in fluid communication with, and adapted for receiving produced water from, one or more GOSPs. The one or more GOSPs are in fluid communication with, and adapted for, receiving a stream containing oil and/or gas, and water, from one or more producing wells.

In an embodiment, the present disclosure directed to a method for sequestering CO₂ comprising using a managed ecosystem. Produced water is obtained and treated in a produced water treatment sub-system that discharges purified produced water. An effective quantity of the purified produced water is piped into the managed ecosystem to sustain the managed ecosystem. The managed ecosystem biologically sequesters CO₂ by photosynthetically absorbing CO₂ from the atmosphere, wherein carbon is transformed as is known into carbon in biomass (trunks, branches, foliage, stems, and roots) and decomposition of carbon into soil within the ground medium of a floor of the managed ecosystem.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

The process of the disclosure will be described in more detail below and with reference to the attached drawings in which the same number is used for the same or similar elements, and where:

FIG. 1 is a flow chart showing conventional disposal of produced water;

FIG. 2 is a flow chart showing the produced water within a closed cycle including a managed ecosystem;

FIG. 3 is a schematic depiction of a managed ecosystem during establishment; and

FIG. 4 is a schematic depiction of an established managed ecosystem.

### DETAILED DESCRIPTION OF CERTAIN EMBODIMENTS OF THE DISCLOSURE

Disclosed herein are processes and systems that economically and ecologically use produced water from oil and/or gas recovery operations to sustain an ecosystem of mangrove and/or seagrass. Managed ecosystems and methods for using managed ecosystems for sequestering carbon dioxide are described herein, using produced water from oil and/or gas recovery operations. The produced water, as obtained and purified, is used to create and sustain a managed ecosystem that supports saline-tolerant vegetation. The managed ecosystem biologically sequesters carbon dioxide by photosynthetically absorbing carbon dioxide from the atmosphere and by decomposition into a layer of sediment on the ecosystem floor.

As used herein the term “produced water” refers to water obtained from oil and/or gas recovery operations, including from subterranean formations by petroleum or natural gas producing wells, and/or water generated from gas and oil separation plants (GOSP), and/or water-oil separation plants (which may be part of a GOSP or a separate plant). Water of high salinity is co-extracted from subterranean oil and gas reserves with the oil and gas. This water is extracted as a by-product and is subsequently separated from the gas or oil, and such water separated from the gas and oil is also referred to as produced water. Produced water can include water that is naturally occurring in the subterranean formation, water injected into the subterranean formation to force oil and gas in the subterranean formation towards the producing well, other water extracted from the subterranean formation, or combinations of these.

As used herein the term “injection well” or “injector well” refers to a well in which fluids are injected, in some embodiments with the function of maintaining pressure in a subterranean oil and/or gas reservoirs.

As used herein the term “brackish water” refers to water with a salt concentration in the range of from 0.5-40 parts per thousand (ppt), 0.5-35 ppt, 0.5-15 ppt, 0.5-2 ppt, 2-40 ppt, 2-35 ppt, 0.5-15 ppt, 15-40 ppt, 15-35 ppt, or 20-40 ppt.

As used herein the term “saline-tolerant vegetation” refers to vegetation that can survive in water that has a salt content of brackish water. In some embodiments, it can refer to halophytes. In some embodiments, saline-tolerant vegetation includes but is not limited to one or more of mangrove trees, tidal marshes, and seagrasses. In some embodiments, saline-tolerant vegetation includes but is not limited to one or more of mangrove trees, tidal marshes, seagrasses, Casuarina equisetifolia, cordgrass, yerba mansa, saltbush, babassu, switchgrass, pickleweed, sea spinach, shoreline purslane, seep-weeds, sea purslane, or saltworts. In some embodiments, saline-tolerant vegetation is one or more species that is partially submerged upon maturity including but not limited to mangrove trees, tidal marshes, Casuarina equisetifolia, cordgrass, saltbush, babassu, pickleweed, sea purslane, seep-weeds and saltworts. In some embodiments, saline-tolerant vegetation is one or more species that is fully submerged upon maturity including but not limited to seagrasses.

Such saline-tolerant vegetation biologically sequesters carbon by photosynthetically absorbing CO₂ from the atmosphere, wherein carbon is transformed as is known into carbon in biomass (trunks, branches, foliage, stems, and roots) and decomposition of soil into a layer of sediment that forms or mixes within ground medium of a basin floor of a managed ecosystem described herein.

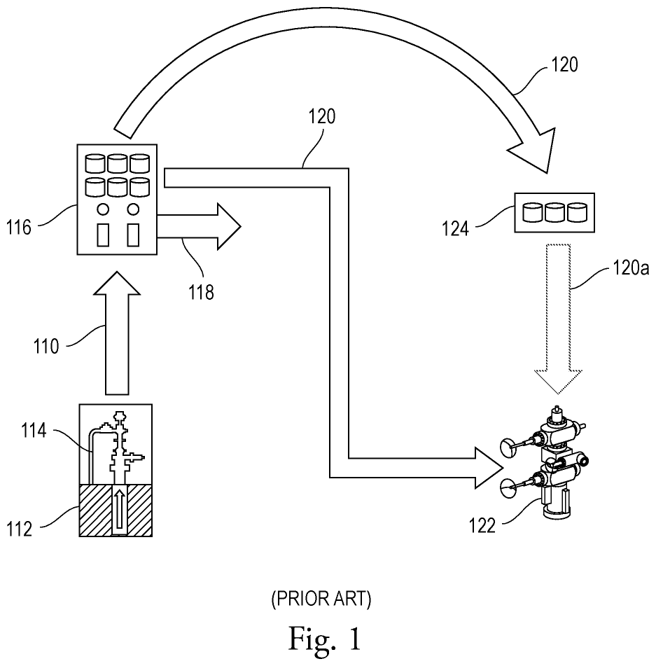

FIG. 1 shows a typical disposal process for produced water in oil and/or gas recovery operations. The oil and/or gas recovery systems generally includes one or more producing wells (114) that is within a subterranean formation (112), one or more GOSPs (116), one or more injection wells (122), and optionally one or more storage structures (124). During oil and/or gas recovery operations, a mixed fluid stream (110) from a subterranean formation (112) containing oil and/or gas, with water in the stream (110), proceeds from a producing well (114) via manifold flow lines to one or more GOSPs (116). Typically, one or more producing wells (114) can feed one or more GOSPs with plural manifolds. Oil and/or gas (118) is recovered, typically as separate streams (not shown), and produced water (120) from the one or more GOSPs (116) is then piped-transported to one or more injection wells (122). In some operations, produced water (120) is directed first to a storage structure (124), which can be typically can be, for example, one or more subterranean wells, one or more reservoirs and/or one or more tanks, and produced water (120a) from the storage structure (124) is directed to one or more injection wells (122).

Discharged water from the GOSP has a salinity level, for example typically in the range of about 15-25 parts per thousand (ppt). The quantity of water produced is voluminous, with some GOSPs generating 40,000-80,000 barrels of water per day (bwpd) produced at some GOSPs. Thus, there is a clear and long-standing need to provide an efficient and economical process for the disposal of this mostly unused resource of produced water in order to facilitate and simplify their environmentally acceptable disposal.

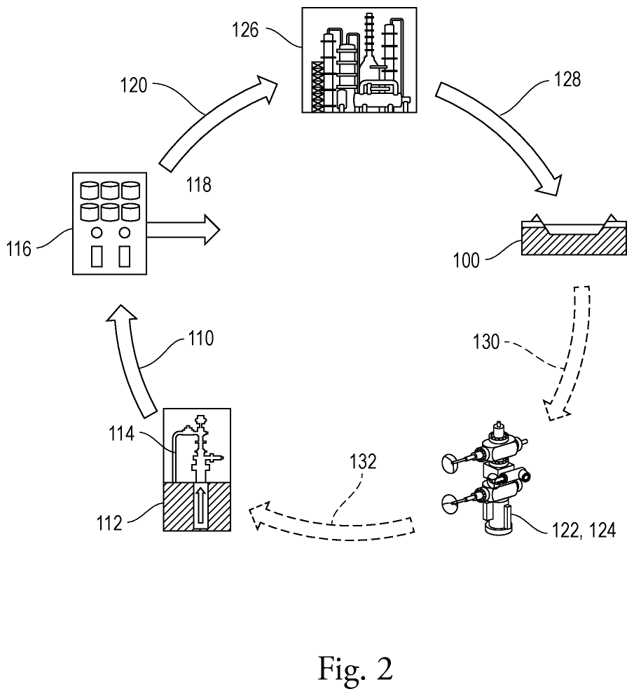

FIG. 2 shows an embodiment of a process using a managed ecosystem described herein is shown. This represents a closed-loop process for effective utilization of produced water. This closed-looped process operates as an integrated process for produced water utilization and storage. In addition, the system herein adds the significant benefit of carbon-capture. As in the conventional process described in conjunction with FIG. 1, a mixed fluid stream (110) from a subterranean formation (112) containing oil and/or gas, and water, is directed from one or more producing wells (114) to one or more GOSPs (116), typically with plural manifolds. Oil and/or gas (118), which can be received as a single stream or as separate streams, is transported and/or further processed as is known. Produced water (120) from the one or more GOSPs (116) is sent to a produced water treatment sub-system (126) for further treatment and to produce purified produced water (128) that is within the ranges of salinities as described herein. In certain embodiments the purified produced water (128) corresponding to that of brackish water. In certain embodiments the purified produced water (128) has a salinity concentration in the range of about 5-40, 5-25, 10-40, 10-35, 20-35 or 20-40 ppt, and is free of, or substantially free of, toxic contaminants. For example, in the purified produced water (128), the level of calcium does not exceed 100 mg/L, the level of iron does not exceed 0.3 mg/L iron, the level of magnesium does not exceed 50 mg/L, the level of potassium does not exceed 12 mg/L, the level of sulphates does not exceed 250 mg/L, and the level of aromatic hydrocarbons does not exceed 0.0004 mg/L. The water treatment sub-system (126) can be one or more separate sub-system as schematically shown in FIG. 2 that is/are in fluid communication with the GOSP(s) (116) via the stream (120). Further, the water treatment sub-system (126) can be integrated with the GOSP(s) (116) (not shown), whereby the stream (120) is not an external stream but rather is one or more internal streams within the GOSP(s) (116).

The system and process of herein provides useful water in an already water-challenged area of land. By using a circular closed-loop cycle, the produced water can still be used and sent to injection wells, as was previously the typical use, but it can also benefit in sustaining an artificial ecosystem; in other words, using the produced water in the ecosystem does not negatively impact the already established use for produced water. The present invention reduces costs associated with drilling disposal wells for unused produced wells and reduced pollution associated with the produced wells.

The salinity level of the water is regulated by its original source and/or the produced water treatment sub-system(s) is important to the survivability of the managed ecosystem. In certain embodiments, the sub-system (126) carries out desalination operations to partially desalinate the produced water, for instance to be within the range of brackish water as described herein. In addition to reducing salinity levels (if necessary) to within the range of brackish water, the produced water is treated in the sub-system (126) so that is substantially free of, or contains tolerable levels of, contaminants such as calcium, iron, magnesium, potassium, sulphates, and aromatic hydrocarbons. Produced water can include flow-back water from downhole processes in drilled hydrocarbon wells. The physical and chemical characteristics of the produced water can change with time. The contaminants of this produced water such as total dissolved solids (TDS), oil and grease, suspended solids, dispersed oil, dissolved and volatile organic compounds, heavy metals, radionuclides, dissolved gasses and bacteria, can also vary, requiring enhanced processing to ensure the output water is of the desired quality and salinity necessary for mangrove and seagrass survivability. Consistency and quality of the purified produced water remains important and must be monitored and maintained.

Additionally, in certain embodiments, certain bacteria present in produced water can sometimes be tolerated by the mangrove/seagrass ecosystem. In some embodiments the produced water treatment sub-system (126) is selected and/or operated to allow bacteria to be retained in the purified produced water (128) that is capable of using simple methyl compounds as a source of carbon and energy. Organisms of this nature are known in general as methylotrophs, and bacteria of this nature includes methanotrophs, which grow aerobically while requiring a single carbon atom compound to survive. Methanotrophs metabolize methane as a source of carbon, and traces can be found in produced water. These kinds of bacteria, present in naturally occurring mangrove formation, can be overtly allowed as part of the purified produced water and can attain energy from the compounds including sulphates can also be present in the produced water, making it beneficial to the managed ecosystem (100) herein.

The treatment process in the produced water treatment sub-system (126) can entail one or more processes and sub-systems known for use in water and gas treatment facilities. Any one or more of the following embodiments are contemplated. Treatment in the produced water treatment sub-system (126) can comprise a physical process including a microfiltration sub-system. Treatment in the produced water treatment sub-system (126) can comprise a physical process including an ultrafiltration sub-system. Treatment in the produced water treatment sub-system (126) can comprise a physical process including a nanofiltration sub-system. Treatment in the produced water treatment sub-system (126) can comprise a physical process including a polymeric membrane sub-system. Treatment in the produced water treatment sub-system (126) can comprise a physical process including a ceramic membrane sub-system. Treatment in the produced water treatment sub-system (126) can comprise a physical process including a reverse osmosis sub-system. Treatment in the produced water treatment sub-system (126) can comprise a physical process including a hydrocyclone sub-system. Treatment in the produced water treatment sub-system (126) can comprise a physical process including an evaporation pond sub-system. Treatment in the produced water treatment sub-system (126) can comprise a physical process including a gas flotation sub-system. Treatment in the produced water treatment sub-system (126) can comprise a physical process including a media filtration sub-system. Treatment in the produced water treatment sub-system (126) can comprise a physical process including an adsorption sub-system. Treatment in the produced water treatment sub-system (126) can comprise a chemical process including an ion exchange sub-system. Treatment in the produced water treatment sub-system (126) can comprise a chemical process including an ion exchange sub-system. Treatment in the produced water treatment sub-system (126) can comprise a chemical process including a precipitation sub-system. Treatment in the produced water treatment sub-system (126) can comprise a chemical process including a chemical oxidation sub-system. Treatment in the produced water treatment sub-system (126) can comprise a chemical process including a freeze thaw evaporation sub-system. Treatment in the produced water treatment sub-system (126) can comprise a chemical process including a sub-system integrating evaporation/condensation cycles using thermal distillation and heat exchange mechanisms. Treatment in the produced water treatment sub-system (126) can comprise a chemical process including a macro-porous polymer extraction sub-system. Treatment in the produced water treatment sub-system (126) can comprise an electrochemical process including an electrodialysis sub-system. Treatment in the produced water treatment sub-system (126) can comprise an electrochemical process including an electrodialysis reversal sub-system. Treatment in the produced water treatment sub-system (126) can comprise a biological process including an activated sludge sub-system. Treatment in the produced water treatment sub-system (126) can comprise a biological process including a biological aerated filter sub-system. Treatment in the produced water treatment sub-system (126) can comprise a biological process including a microbial capacitive desalination cell sub-system. Treatment in the produced water treatment sub-system (126) can comprise a biological process including a microalgae treatment sub-system. Treatment in the produced water treatment sub-system (126) can comprise a thermal process including a multistage flash sub-system. Treatment in the produced water treatment sub-system (126) can comprise a thermal process including a multieffect distillation sub-system. Treatment in the produced water treatment sub-system (126) can comprise a thermal process including a vapor compression distillation sub-system. Treatment in the produced water treatment sub-system (126) can comprise a thermal process including a multieffect distillation-vapor compression hybrid sub-system.

In some embodiments (not shown), all or a portion of the purified produced water (128) from the produced water treatment sub-system (126) is subjected to an additional treatment sub-system to produce additionally treated purified produced water. Any one or more of the following embodiments are contemplated. The additional treatment sub-system can comprise a membrane filtration sub-system. The additional treatment sub-system can comprise an electrolytic coagulation and disinfection sub-system. In some embodiments, all or a portion of the purified produced water (128) from the produced water treatment sub-system (126) for instance, 0-100, 0-90, 0-80, 0-70, 10-100, 10-90, 10-80, 10-70, 20-100, 20-90, 20-80, 20-70, 30-100, 30-90, 30-80 or 30-70 volume % of the purified produced water, is subjected to one more of these or other types of treatment. In some embodiments, when a portion of the purified produced water (128) is subjected to additional treatment, the additionally treated purified produced water is combined with all or a part of the remaining portion of the purified produced water (128).

A managed ecosystem (100) as described below is provided. An effective quantity of the purified produced water (128) (optionally with all or a portion thereof subjected to additional treatment) is transported to the managed ecosystem (100), for example by a flowline or pipeline. In certain embodiments herein, for instance where the managed ecosystem (100) is smaller in scale, the purified produced water (128) can be transported by containers, for instance with road and/or rail vehicles. The effective quantity of purified produced water is an amount that is sufficient to sustain saline-tolerant vegetation within the managed ecosystem. In some embodiments, the additionally treated purified produced water optionally combined with purified produced water that bypasses additional treatment, so that the combined stream is the sole or primary source of brackish water for the managed ecosystem (100) herein. In some embodiments, the additionally treated purified produced water from these or other types of treatment is used as the sole or primary source of brackish water for the managed ecosystem (100) herein.

Advantageously, water from the GOSP(s) (116) that would otherwise be used in injection wells is diverted for use in the managed ecosystem (100). For example, during period of time when the managed ecosystem (100) receives purified produced water stream (128) (optionally with all or a portion thereof subjected to additional treatment), 5-100, 5-95, 5-90, 5-80, 5-70, 10-100, 10-95, 10-90, 10-80, 10-70, 20-100, 20-95, 20-90, 20-80, 20-70, 30-100, 30-95, 30-90, 30-80 or 30-70, volume % of the total water effluent from the GOSP(s) (116) is diverted to the managed ecosystem (100).

In some embodiments, water (130) is removed from the managed ecosystem (100) and directed into one or more injection wells (122) and/or one or more storage structures (124), for instance one or more tanks, reservoirs, or wells, also as described in conjunction with to FIG. 1.

In some embodiments, once the water (130) is directed into one or more injection wells (122) and/or storage structures (124), the process effectively can repeat. Water (132) from one or more injection wells (122) and/or storage structures (124) can be used again to force a stream (110) of oil and/or gas with water therein from subterranean formations (112), or for other purposes where it ends up together with oil and/or gas and is transported to one or more GOSPs (116) for separation. This represents the closed-loop embodiment shown in FIG. 2, a produced water utilization and disposal process. In this closed-looped process, all segments in the matrix support each other, and operates as a carbon-capture process, and a produced water utilization and storage process.

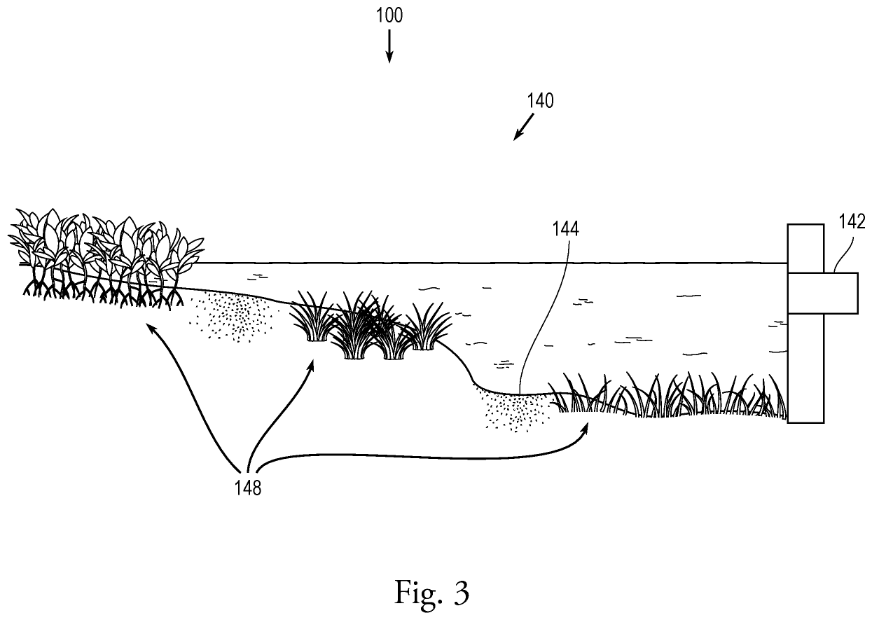

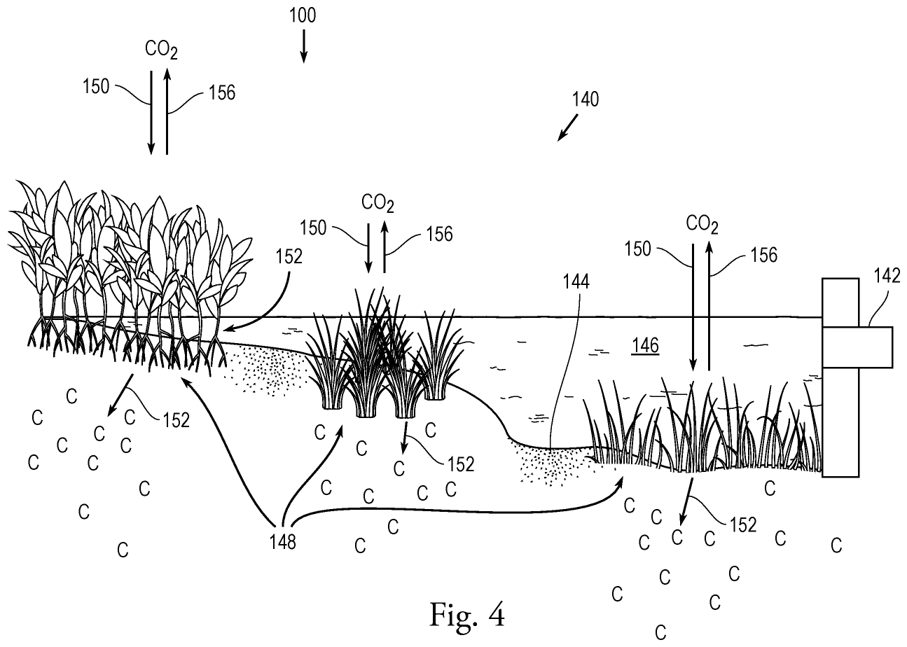

FIGS. 3 and 4 schematically depict a managed ecosystem (100). The managed ecosystem (100) generally comprises a basin (140) and one or more inlets (142) for receiving water, from the purified produced water stream (128). The fluid communication between the water treatment sub-systems (126) can be by any known flow structure such as pipelines and/or aqueducts. Optionally, one or more outlets can be provided in the basin (140), which can be the same flow structure as the inlet(s) (142) or separate flow structures. For example, flow of water can be reversed to drain or partially drain the basin (140). The influent flowline (142) and an optional separate outlet flowline can separately flow directly to and from the basin (140). Alternatively, a leader line can be present to flow directly into and from the basin (140), wherein the influent flowline (142) and an optional effluent flowline are connected to the leader line upstream of the basin. The inlet(s) and optional outlet(s) function to controllably add produced water to and/or remove water from the basin. In some embodiments, separate lines are provided to allow for continuous operation. In other embodiments, an overt outlet is not required.

The basin (140) used herein can be a natural land formation, of man-made construct, or a combination thereof. For instance, the basin (140) can be similar in construction to reservoirs, artificial ponds, landscaping ponds, artificial pools, aquacultural ecosystems, or other man-made structures capable of holding water and saline-tolerant vegetation in a suitable ground medium (144). The inlet(s) and optional outlet(s) can be formed within man-made portions of the basin structure, and/or formed on or within natural land formation portions of the basin structure, such as flowing from a surface level or a buried water pipeline directing purified produced water (128) at a level of some depth of the basin (140). It is to be understood that the managed ecosystem (100) includes necessary fluid flow structures including pipelines and/or other conduits, including open air conduits such as channels, and associated valves, feeders and/or pumps. In addition, control and monitoring equipment can be included.

In some embodiments the basin (140) is formed as a contained environment and ecosystem where the inflow and outflow of water is closely managed. For instance, the floor of the basin (140) can be formed of a dense layer of sand, with a layer of soil and/or a liner above the dense layer of sand, to minimize or eliminate any seepage of water through the bottom.

A perimeter of the basin (140) is configured and dimensioned to contain the water therein, with boundaries formed, for instance, of walls and/or berms of suitable height and construction. In certain embodiments, the depth of the basin at or proximate to the perimeter boundaries is smaller and can gradually increase away from the perimeter boundaries in a sloped fashion to the full depth, so as to accommodate ground medium (144) that supports saline-tolerant vegetation; in such embodiments, the saline-tolerant vegetation can be supported underwater in the ground medium on those sloped portions, and also have portions thereof that pass through the water surface into the air above, for instance, mangrove trees rooted at the perimeter. In certain embodiments, the basin can have substantially vertical perimeter boundaries embodiments, and the water depth is of a suitable magnitude to permit saline-tolerant vegetation to be rooted in the ground medium and have portions thereof that pass through the water surface into the air above; in such embodiments, the saline-tolerant vegetation can be supported underwater in the ground medium across the area of the basin of suitable depth, and also have portions thereof that pass through the water surface into the air above, for instance, as rows of mangrove trees.

In certain embodiments, the only source of water in the managed ecosystem (100), other than natural rainfall over the area of the basin, is tightly controlled and comprises or consist of the purified produced water (128) described herein; in such embodiments, the walls and/or berms can include drainage features that are configured and dimensioned to divert runoff water, or naturally existing or later-formed streams, away from the basin (140).

In certain embodiments, the managed ecosystem (100) can accept other sources of water, for instance, where the perimeter of the basin (140) is be formed with features that are configured and dimensioned to overtly direct runoff water, or naturally existing or later-formed streams, into the basin (140). In this manner, a quantity of fresh water (that is, obtained from rainwater) is mixed with the purified produced water that is intentionally used to support the managed ecosystem (100).

In some embodiments, a managed ecosystem (100) is constructed as one or more modules, where the structure of the basin (140) is formed and constructed as modular unit, for instance with footprint dimensions similar to a standard 8 by 20 feet or 8 by 40 feet ISO shipping container(s) (2.43 by 6.06 meters or 2.43 by 12.12 meters). In further embodiments, plural modules having suitable dimensions are configured to be constructed as a single system as the basin (140). The necessary fluid flow structures including pipelines and/or other conduits, and associated valves, feeders and/or pumps, can be contained within or upon the module. In certain embodiments the ecosystem (100) is further self-contained so there is an outlet in fluid communication with a discharged water holding or receiving structure.

In some embodiments, a managed ecosystem (100) comprises or consists of a plurality of small basins having a water surface area in the range of about 100 centimeters squared (cm²) to about 100 meters squared (m²), about 100 cm² to about 20 m², about 100 cm² to about 10 m², about 100 cm² to about 5 m², about 100 cm² to about 1 m², about 500 cm² to about 100 m², about 500 cm² to about 20 m², about 500 cm² to about 10 m², about 500 cm² to about 5 m², about 500 cm² to about 1 m², about 1-100 m², about 1-20 m², about 1-10 m² or about 1-5 m². The average depth of the water in the small basins can be in the range of about 10 cm to about 2 m, 10 cm to about 1 m, 10 cm to about 0.5 m, 20 cm to about 2 m, 20 cm to about 1 m or 20 cm to about 0.5 m. These small basins can be used individually or in a network containing a plurality of basins each in fluid communication with the source of purified produced water, via a network or other structure. In some embodiments purified produced water from the influent flowline is piped into several basins via a manifold, and discharged water is passed to the effluent flowline via the same or different manifold. In some embodiments a fluid network of interconnected basins is provided whereby each basin is fluidly connected to one or more other basins, and wherein purified produced water from the influent flowline is piped into one or more basins that feed other basins, and wherein discharged water is passed to the effluent flowline via one or more basins that is fed from other basins. In some embodiments purified produced water from the influent flowline is piped into several basins via a manifold; discharged water is passed to the effluent flowline via the same or different manifold; and at least one or more of the basins that receive water from the manifold are fluidly connected to one or more other basins, wherein purified produced water from the basins fed by the manifold feeds the other basins. In some embodiments the system includes piping and interconnected nozzles and/or shower heads arranged in fluid communication with the source of purified produced water and configured and arranged to shower purified produced water onto saline-tolerant vegetation sustained in each of the plurality of basins. These basins can be arranged for instance in an array, for instance, of 2-20 by 2-20, or on a larger scale of hundreds or thousands of individual basins.

In other embodiments the basins are of a larger dimension, where one or a small plurality, for instance, two, three, up for instance about ten, are arranged fluid communication with the source of purified produced water (128). In such embodiments of a larger scale managed ecosystem (100), the water surface area dimension can be for instance in the range of about 50-300,000, 50-100,000, 50-50,000, 50-30,000, 50-15,000, 50-5,000, 50-1,000, 100-300,000, 100-100,000, 100-50,000, 100-30,000, 100-15,000, 100-5,000, 100-1,000, 500-300,000, 500-100,000, 500-50,000, 500-30,000, 500-15,000, 500-5,000 or 500-1,000 m². The average depth of the water in basins of larger dimension can be in the range of about 0.5-10, 0.5-5, 0.5-3, 0.5-2, 1-10, 1-5, 1-3 or 1-2 m.

The basins (of any dimensional range) are suitably configured to also hold an effective quantity of a suitable ground medium (144) forming a basin floor. The ground medium can include a natural and/or artificial medium including one or more of sand, soil or clay. At least certain portions of the basin area contain ground medium (144) selected to support saline-tolerant vegetation, whereas any remaining portions contain other ground medium or none at all. For example, about 5-100, 5-95, 5-90, 5-80, 5-50, 5-20, 10-100, 10-95, 10-90, 10-80, 10-50, 10-20, 20-100, 20-95, 20-90, 20-80, or 20-50 percent (by area) of the basin contains ground medium selected to support species of saline-tolerant vegetation selected for the managed ecosystem (100). The basin can be formed with features to hold media in certain locations, for instance as islands, with others containing mainly water. Types of ground media that are selected to support species of saline-tolerant vegetation includes such media containing any necessary compositional and/or physical properties to support the selected species of saline-tolerant vegetation nutritionally via macro and/or micro nutrients, and/or structurally.

In certain embodiments the geographic location of the ecosystem (100) is one with little or no seismic hydrocarbon activity. For example, suitable land includes that which is designated and/or sanctioned as a “no-drilling” and this does not undergo seismic activity due to human interaction. Provision of the ecosystem (100) is areas with little or no seismic hydrocarbon activity can prevent detrimental impact to life forms therein.

With reference to FIG. 3, an establishment phase is schematically depicted. Initially, the managed ecosystem (100) comprises species of saline-tolerant vegetation (148) in germination phase. During an establishment phase of the managed ecosystem, one or more species of saline-tolerant vegetation (148) are planted at various locations in the basin (140), including locations that will ultimately result in the vegetation being completely submerged or partially submerged, depending on the species. In certain embodiments, one or more species of saline-tolerant vegetation (148) are established in the ground medium of sloped perimeters of the basin. In certain embodiments, one or more species of saline-tolerant vegetation (148) are established in the ground medium at deep parts of the basin. In certain embodiments, one or more species of saline-tolerant vegetation (148) are established in the ground medium upon one or more fully or partially exposed islands formed in the basin. In certain embodiments, the basin can have substantially vertical perimeter walls embodiments, with relatively shallow depth, and one or more species of saline-tolerant vegetation (148) are established in the ground medium and are partially submerged.

In certain embodiments, germination of saline-tolerant vegetation seedlings takes approximately 3-6 months depending on the conditions and selected species. Volumes and levels of water in the managed ecosystem (100) can be maintained by throttling back water at the source, for instance at the GOSP(s).

When the vegetation is initially germinated, in certain embodiments a source of water used for the germination and early growth stages of the vegetation can comprise a source other than purified produced water stream (128) disclosed herein, for instance a brackish water stream obtained from natural sources or obtained from other treatment systems (not shown). In other embodiments the purified produced water stream (128) is sufficiently free of toxins and of ideal salinity levels to support germination and/or early growth phase of the saline-tolerant vegetation. In further embodiments, a combination of water from the purified produced water stream (128) disclosed herein and water from another source are used for the germination and/or early growth phases of the saline-tolerant vegetation.

After the vegetation (148) has been established in the managed ecosystem (100), now referred to as an established managed ecosystem, the purified produced water stream (128) is passed to the basin (140) to fill the basin to a desired water level, shown as water (146) in FIG. 4. In certain embodiments the managed ecosystem (100) at this established stage is ready to be incorporated within the process flow steps shown in FIG. 2. That is, the established managed ecosystem can receive the purified produced water stream [(128) in FIG. 2] and can also discharge back into the cycle water [(130) in FIG. 2] from the basin (140), in a continuous or non-continuous manner.

With reference to FIG. 4, the amount of purified produced water that is piped in is sufficient to sustain saline-tolerant vegetation (148) within the managed ecosystem (100). The managed ecosystem biologically sequesters carbon by photosynthetically absorbing CO₂ (150) from the atmosphere, wherein carbon is sequestered (152), by transforming it into carbonaceous biomass of the vegetation (148) (trunks, branches, foliage, stems, and roots) and decomposition of biomass (154) into soil or sediment that forms “blue carbon” and mixes within the ground medium (144) of a floor of the managed ecosystem (100). The carbon is trapped in layers of sediments which make up the soil with most carbon generally stored at the top sediment layer. This is because the bulk density and sand content in the sediment increases from top to bottom. In certain embodiments and/or species of vegetation, the vegetation can re-establish itself naturally. In addition, during respiration cycles of certain species of saline-tolerant vegetation (148), CO₂ (156) is released. However, the net effect is carbon sequestration.

In operation, water loss will occur, for example by uptake by the saline-tolerant vegetation and evaporation. This will increase the overall salt concentration as fresh water is evaporated or taken up by vegetation. In other embodiments water loss will also occur by drainage into the ground medium. In addition, in certain embodiments species of saline-tolerant vegetation, such as mangroves, can uptake a certain percentage of salt.

In embodiments in which water from the managed ecosystem (100) is discharged, for instance as shown with respect to FIG. 2, the salinity of that effluent stream flowing is dependent on the salt concentration of the influent flowing into the managed ecosystem, and the amount and salinity of water from other sources that may be within the managed ecosystem (100), for example during establishment. Over time, as water evaporates and is taken up by vegetation, salinity increases as volume decreases, and additional produced water is added to the managed water ecosystem (100).

For example, it has been shown that with a 9 feet×9 feet (about 2.74×2.74 m) spacing, over 1000 mangrove trees can be planted in a two acre plot of land (about 8094 meters). Recent research has also suggested approximately 0.226 tons (about 241.3 kilograms (kg)) of CO₂ is sequestered annually per tree, which results in 226 tons (241,311 kg) of CO₂ that can be sequestered in a two acre managed ecosystem (100).

With estimated volumes of 40,000 bwpd to 80,000 bwpd produced at some GOSPs, if only 50% of the water is allocated for the mangrove and seagrass development, thousands of barrels of produced water are still left for injection into disposal wells for waterflooding and pressure maintenance for downhole oil producing strategies.

The system includes a downhole actuation system (not shown) that can be controlled from the surface to actuate digitally enabled downhole devices, tools, and/or instruments. Actuation of different devices, tools, and/or instruments enables the execution of discrete drilling workflows. The actuation system is a separate system that can be seamlessly integrated with downhole devices, tools, and/or instruments. The present invention can be integrated with existing infrastructure at our GOSPs and water-oil separators (WOSEPs) within GOSPs that treats the water for contaminants.

In some embodiments, the system and/or individual apparatus of the system can include a controller to monitor and adjust the system as desired. A controller can direct any of the parameters within the system depending upon the desired operating conditions, which may, for example, be based on tolerance levels of the vegetation and/or existing volumetric and/or salinity levels of water in a managed ecosystem (100). The controller can adjust or regulate valves, feeders or pumps associated with each potential flow based upon one or more signals generated by sensors or timers positioned within the system or individual apparatus. The controller can also adjust or regulate valves, feeders or pumps associated with each potential flow based upon one or more signals generated by sensors or timers, which indicate a specific trend, for example an upward or downward trend in a characteristic or property of the system over a predetermined period of time. For example, a sensor in an effluent stream can generate a signal indicating that the concentration of one or more toxins or the salinity level has reached a predetermined value or trend, thereby triggering the controller to perform some act upstream from, downstream from, or at the sensor. One or more sensors can be utilized in or with the one or more apparatus or streams of the system to provide an indication or characteristic of the state or condition of any one or more processes being performed in the system.

The controller of one or more embodiments of the invention provide a versatile unit having multiple modes of operation, which can respond to multiple inputs to effectively establish and/or sustain the managed ecosystem (100) herein. The controller can be implemented using one or more computer systems which can be, for example, a general-purpose computer. Alternatively, the computer system can include specially-programmed, special-purpose hardware, for example, an application-specific integrated circuit (ASIC) or controllers intended for water contained systems.

The computer system can include one or more processors typically connected to one or more memory devices, which can comprise, for example, any one or more of a disk drive memory, a flash memory device, a RAM memory device, or other device for storing data. The memory is typically used for storing programs and data during operation of the system. For example, the memory can be used for storing historical data relating to the parameters over a period of time, as well as operating data. Software, including programming code that implements embodiments of the invention, can be stored on a computer readable and/or writeable nonvolatile recording medium, and then typically copied into memory wherein it can then be executed by one or more processors. Such programming code can be written in any of a plurality of programming languages or combinations thereof. Components of the computer system can be coupled by one or more interconnection mechanisms, which can include one or more busses, e.g., between components that are integrated within a same device, and/or a network, e.g., between components that reside on separate discrete devices. The interconnection mechanism typically enables communications, e.g., data, instructions, to be exchanged between components of the system. The computer system can also include one or more input devices, for example, a keyboard, mouse, trackball, microphone, touch screen, and other man-machine interface devices as well as one or more output devices, for example, a printing device, display screen, or speaker. In addition, the computer system can contain one or more interfaces that can connect the computer system to a communication network, in addition or as an alternative to the network that can be formed by one or more of the components of the system.

According to one or more embodiments of the invention, the one or more input devices can include sensors for measuring any one or more parameters of system and/or components thereof. Alternatively, one or more of the sensors, pumps, or other components of the system, including metering valves or volumetric feeders, can be connected to a communication network that is operatively coupled to the computer system. Any one or more of the above can be coupled to another computer system or component to communicate with the computer system over one or more communication networks. Such a configuration permits any sensor or signal-generating device to be located at a significant distance from the computer system and/or allow any sensor to be located at a significant distance from any subsystem and/or the controller, while still providing data therebetween. Such communication mechanisms can be affected by utilizing any suitable technique including but not limited to those utilizing wireless protocols.

Although the computer system is described by way of example as one type of computer system upon which various aspects of the invention can be practiced, it should be appreciated that the invention is not limited to being implemented in software, or on the computer system as exemplarily shown. Indeed, rather than implemented on, for example, a general purpose computer system, the controller, or components or subsections thereof, can alternatively be implemented as a dedicated system or as a dedicated programmable logic controller (PLC) or in a distributed control system. Further, it should be appreciated that one or more features or aspects of the invention can be implemented in software, hardware or firmware, or any combination thereof. For example, one or more segments of an algorithm executable by a controller can be performed in separate computers, which in turn, can be in communication through one or more networks.

In some embodiments, one or more sensors can be included at locations throughout of the managed ecosystem (100), which are in communication with a manual operator or an automated control system to implement a suitable process modification in a programmable logic controlled managed ecosystem (100). In one embodiment, managed ecosystem (100) includes a controller which can be any suitable programmed or dedicated computer system, PLC, or distributed control system. The salinity and/or concentration of selected toxins can be measured in the purified produced water, in the basin, in the influent flowline and/or in the effluent flowline concentration of certain toxins can be measured at in the basin. Sensors known to those of ordinary skill in the art of process control apparatus can include those based on laser-induced fluorescence or any other sensor suitable for in situ real time monitoring of the concentration of organic or inorganic compounds in the effluent or other property or characteristic of the system. Sensors that may be used include submersible sensors for use in oil-in-water measurement which use UV fluorescence for detection, such as enviroFlu-HC sensors available from TriOS Optical Sensors (Oldenburg, Germany). The sensors may comprise lenses which are coated or otherwise treated to prevent or limit the amount of fouling or film that occurs on the lenses in the environment of the brackish water. In certain embodiments the controller implemented using one or more computer systems that includes stored in a memory thereof programming code that implements feedback and/or feedforward action based on inputs from the one or more sensors. For example, when one or more sensors in the system generate a signal that the concentration of one or more organic and/or inorganic compounds exceeds a predetermined concentration, the control system can implement a responsive action such as a suitable feedback action or feedforward action, including but not limited to any one or more of: removing water from the managed ecosystem (100); adjusting flow of effluent water; adding water (fresh or brackish water) from a source other than the produced water treatment sub-system (126) to the managed ecosystem (100); adding new purified produced water (128) to the managed ecosystem (100); adjusting flow of the new purified produced water (128) introduced via the inlet; adjusting salinity levels and/or levels of toxins of the produced water from the GOSP(s) (116) and/or of the purified produced water from the water treatment sub-system (126); and/or other modifications as described above or that will be apparent to those of ordinary skill in the art.

It will be understood from the above description that the process of the present disclosure provides a cost effective and environmentally acceptable means for using produced water from a well to sustain an ecosystem of mangrove and/or seagrass.

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms ““including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings are shown accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A managed ecosystem utilizing purified produced water from an oil and/or gas recovery systems comprising:
a basin having a ground medium and a perimeter that is configured and dimensioned to hold a quantity of water;
an influent flowline in fluid communication with a source of, and adapted for receiving and discharging into the basin, purified produced water from an oil and/or gas recovery system; and
a quantity of saline-tolerant vegetation in the ground medium of the basin that is sustained by the purified produced water;
wherein oil and/or gas recovery system comprise one or more producing wells, one or more gas and oil separation plants and one or more a produced water treatment sub-systems, and wherein
the source of purified produced water comprise the one or more produced water treatment sub-system;
the produced water treatment sub-system is in fluid communication with, and adapted for receiving produced water from, the one or more gas and oil separation plants; and
and the one or more gas and oil separation plants are in fluid communication with, and adapted for, receiving a mixed fluid stream containing oil and/or gas, and water, from the one or more producing wells, and are adapted for discharging water from the mixed fluid stream for passage to the one or more produced water treatment sub-systems.

2. The managed ecosystem as in claim 1, further comprising an effluent flowline in fluid communication with, and adapted for discharging water from the basin into a water storage structure and/or an injector well.

3. The managed ecosystem as in claim 1, wherein the perimeter of the basin is configured and dimensioned to contain the water therein with boundaries formed of walls and/or berms.

4. The managed ecosystem as in claim 3, wherein at least a portion of the boundaries are sloped and have ground medium on the sloped portion to support saline-tolerant vegetation that is rooted in the ground medium and has portions that pass through the water in the basin.

5. The managed ecosystem as in claim 1 comprising a plurality of basins each having a water surface area in the range of about 100 cm² to about 100 m², and each having an average depth of the water in the range of about 10 cm to about 2 m.

6. The managed ecosystem as in claim 5, further comprising a manifold in fluid communication with the influent flowline and the plurality of basins, wherein purified produced water from the influent flowline is piped into the plurality of basins via a manifold.

7. The managed ecosystem as in claim 5, wherein each basin is fluidly connected to one or more other basins, and wherein purified produced water from the influent flowline is piped into one or more basins that feed other basins.

8. The managed ecosystem as in claim 5, further comprising piping and interconnected nozzles and/or shower heads that are arranged in fluid communication with the source of purified produced water, wherein the piping and interconnected nozzles and/or shower heads are configured and arranged to shower purified produced water onto saline-tolerant vegetation sustained in each of the plurality of basins.

9. The managed ecosystem as in claim 1, wherein the basin has a water surface area in the range of about 50-300,000 m² and has an average depth of the water in the range of about 0.5-10 m.

10. The managed ecosystem as in claim 1, wherein the ground medium covers from about 5-100% of the area of a basin floor is covered by ground medium, and wherein the ground medium is selected from the group consisting of sand, soil and clay.

11. The managed ecosystem as in claim 1, wherein the produced water treatment sub-system is selected from the group consisting of microfiltration, ultrafiltration, polymeric membranes, ceramic membranes, reverse osmosis, nanofiltration, hydrocyclones, evaporation pond, gas flotation, media filtration, adsorption, ion exchange, precipitation, chemical oxidation, freeze thaw evaporation, evaporation/condensation cycles using thermal distillation and heat exchange mechanisms, macro-porous polymer extraction, electrodialysis, electrodialysis reversal, activated sludge, biological aerated filters, microbial capacitive desalination cells, microalgae, multistage flash, multieffect distillation, vapor compression distillation, and multieffect distillation-vapor compression hybrid.

12. The managed ecosystem as in claim 1, further comprising an additional treatment sub-system in fluid communication with the produced water treatment sub-system and with the influent flowline, wherein effluent from the additional treatment sub-system is directed to the influent flowline.

13. The managed ecosystem as in claim 12, wherein the additional treatment sub-system is a membrane filtration sub-system or an electrolytic coagulation and disinfection sub-system.

14. The managed ecosystem as in claim 1, further comprising one or more sensors positioned to measure salinity and/or concentration of selected toxins in the purified produced water, in the basin, in the influent flowline and/or in the effluent flowline, and a controller implemented using one or more computer systems that includes stored in a memory thereof programming code that implements, under direction of a processor, feedback and/or feedforward action based on inputs from the one or more sensors, wherein the feedback and/or feedforward action comprises an act selected from the group consisting of removing water from the basin, adding water from a source other than the produced water treatment sub-system, adding new purified produced water to the basin, adjusting flow of purified produced water introduced via the influent flowline, adjusting salinity levels of the purified produced water, adjusting levels of selected toxins of the purified produced water, and combinations of two or more of these acts.

15. The managed ecosystem as claim 1, wherein saline-tolerant vegetation includes one or more of mangrove trees, tidal marshes, seagrasses, Casuarina equisetifolia, cordgrass, yerba mansa, saltbush, babassu, switchgrass, pickleweed, sea spinach, shoreline purslane, seep-weeds, sea purslane, or saltworts.

16. A method for sequestering CO₂ comprising using a managed ecosystem comprising:
providing a managed ecosystem as in claim 1;
treating produced water in the produced water treatment sub-system and discharging therefrom the purified produced water;
directing an effective quantity of the purified produced water to the managed ecosystem via the influent flowline to sustain the saline-tolerant vegetation in the ground medium of the basin;
wherein the saline-tolerant vegetation photosynthetically absorbs CO₂ from the atmosphere and transforms carbon in the CO₂ into biomass, and wherein decomposition of the biomass results in carbon integrating in the ground medium.

17. A method for utilization of produced water from an oil and/or gas recovery systems comprising:
providing a managed ecosystem as in claim 2;
treating produced water in the produced water treatment sub-system and discharging therefrom the purified produced water;
directing an effective quantity of the purified produced water to the managed ecosystem via the influent flowline to sustain the saline-tolerant vegetation in the ground medium of the basin;
removing water from the managed ecosystem via the effluent flowline and directing removed water to a water storage structure and/or an injector well.

18. The method as in claim 16, wherein the purified produced water directed to the managed ecosystem has a salt concentration in the range of from 0.5-40 parts per thousand.

19. The method as in claim 16, wherein the purified produced water contains methanotrophs.
